(19) United States
(12) Patent Application Publication
(10) Pub. No.: US 2009/0163585 A1
(43) Pub. Date: Jun. 25, 2009

(54) Carbosulfane-Based Pesticidal Compositions, Process for Preparing Same, Process for Controlling Insects/Mites/Nematodes, and Use of Said Compositions

(76) Inventor: Jair Sunega, Lagoinha (BR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/817,815

(22) PCT Filed: Mar. 9, 2006
(86) PCT No.: PCT/BR2006/000043

§ 371 Date: Jul. 28, 2008

(30) Foreign Application Priority Data
Mar. 9, 2005 (BR) PI0500857-3

(51) Int. Cl. A01N 43/08; A01P 5/00; A01P 7/02; A01P 7/04

(52) U.S. Cl. 514/469

(57) ABSTRACT

The present invention relates to pesticidal compositions comprising 2,3-dihydro-2,2-dimethylbenzofuran-7-yl(dibutylaminothio)methylcarbamate, namely benzofuranyl methylcarbamate, commonly known as carbosulfane, of structural formula (I). The present invention deals more particularly with compositions comprising this active compound at a high concentration, which makes it the most economical product for sale, more stable during storage and more effective in small quantities, and it may be further combined with one or more inerts. The present invention further discloses a process for preparing said compositions and a process for controlling insects/mites/nematode. The applications for these formulations include the treatment of seeds and leaves. In the latter case, in addition to the diluting agent, a mixture of anionic and non-ionic surfactants have been included in the formulation, so that the solution will become self-emulsifying upon being added to water.

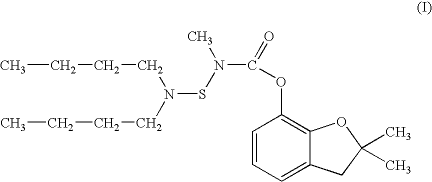

### FIELD OF THE INVENTION

The present invention relates to pesticidal compositions comprising 2,3-dihydro-2,2-dimethylbenzofuran-7-yl(dibutylaminothio)methylcarbamate, namely benzofuranyl methylcarbamate, commonly known as carbosulfane, of structural formula:

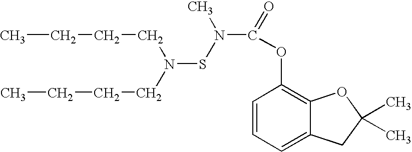

The present invention deals more particularly with compositions comprising this active compound at a high concentration, which makes it the most economical product for sale, more stable during storage and more effective in small quantities, and it may be further combined with one or more inerts.

The present invention further discloses a process for preparing said compositions and a process for controlling insects/mites/nematode.

The applications for these formulations include the treatment of seeds and leaves. In the latter case, in addition to the diluting agent, a mixture of anionic and non-ionic surfactants have been included in the formulation, so that the solution will become self-emulsifying upon being added to water.

### PRIOR ART

Conventional processes of preparing carbosulfane are disclosed in patents BR 7405724-3 and by Di Sanzo et al in patent US T977.008. Other processes of preparing carbosulfane are also discloses, for instance, in patent applications BR 9611643-9, BR 8201595-3, BR 8206288-9, BR 9106095-8 and BR 8305338-7, as well as in patents BR 8201783-2, BR8502202-0 and BR 8306229-7.

Compositions/formulations comprising the active compound carbosulfane are disclosed, for instance in patent applications BR 9306642-0, BR 9005700-7, BR 9400630-0, BR 0114435-9 and BR 8804971-0, as well as in patent BR 8303588-5.

Patent BR 8503623-4 discloses an oil-in-water dispersion for agricultural use, having excellent dispersibility and stability of the insecticidal component during storage and comprising from 1 to 70% by weight of a sulfonyl carbamate, from 1 to 70% by weight of sulfenyl carbamate derivative, from 1 to 10% by weight of polyvinyl alcohol, from 5 to 10% by weight of a urea compound, the balance being water; said dispersion may further contain from 5 to 10% by weight of an epoxy compound based on the weight of the sulfenyl carbamate derivative.

Formulations with concentration ranges of the active compound close to those that are used in the present invention are relevant in the prior art, namely in patent BR 8503623-4, but the active compound is already emulsified for sale. Thus, the formulation disclosed therein, contrary to the present invention, is subject to instability during storage, especially if the medium employed is water, which is known to be an agent that degrades the active compound.

Therefore, the present invention deals more particularly with compositions comprising the active compound carbosulfane at high concentrations, which makes the final product more economical for sale, more stable during the period of storage and more effective in small quantities, and it may further be combined with one or more inert components.

Contrary to what is disclosed in the prior art, the differentiating factor of the presently claimed composition in the treatment of seeds, as compared to the compositions known from the prior art, is the absence of water and/or another adjuvant in the formulation that might instability of the active ingredient. In the case of a formulation for treating leaves, the advantage of the compositions of the present invention over the main commercialized formulations is the absence of surfactant based on alkyl phenol ethoxylate, known as a carcinogenic agent.

### DETAILED DESCRIPTION OF THE INVENTION

The composition comprising the carbosulfane may be applied “pure”, that is to say, without any dilution components for the treatment of seeds. However, the composition is typically applied to the seeds in the form of a pesticidal formulation. This formulation may contain one or more desirable additional components, including but not limited to liquid diluting agents that enable one to dilute the product, improve the adhesion and/or spread of the coating.

The concentrations of the active substances often sold commercially range from 10 to 50% by weight. However, with the present invention one proposes to increase this range so as to embrace from 51 to 90% by weight of these active compounds, preferably from 70 to 80%. However, the concentration may vary according to the application and, for instance, in the case of a formulation for the treatment of seeds, the concentration of the active compound may reach the limit of purity itself of the active compound.

For diluted applications, one may employ liquid diluting agents, such as petroleum distillates, as for example, cyclic or linear, aliphatic or aromatic, branched or non-branched, unsaturated or saturated hydrocarbons, as for instance, AB-9 and/or AB-11, isoparaffin, n-heptane, cyclohexane, in addition to ketones, alcohols, esters, ethers, amides, amines, with chain sizes preferably in the range of C1-C10. Examples of evaluated solvents of the above-mentioned classes are: cyclohexanone, dimethylformamide, propylene carbonate, n-methyl-pirrolidone, among other non-phitotoxic solvents, and/or mixtures thereof, at a concentration ranging from 5 to 49% by weight of the formulation.

For the treatment of seeds, the simple mixture of the active compound with the solvent is sufficient. However, for the treatment of leaves it is recommended to include in the formulation surfactants for the preparation of an emulsifiable concentrate. The possibility of including surfactants in the treatment of seeds in order to enhance the affinity of preparation with water is not excluded.

In the case of the present invention, one employs a mixture of non-ionic and anionic surfactants that do not belong to the class of ethoxylated alkyl phenol. The mixture employed is a mixture of anionic and non-ionic surfactants based on salified alkyl aryl sulfonate and alcoxylated alcohol and alxoxylated fatty ester solubilized into aromatic solvents, for example, AB-9 and/or AB-11, and light alcohols, for example, in the range of C1-C6, which, besides guaranteeing an excellent solubility to the solution even days after the mixing, are environmentally friendly. However, the surfactant mixture may embrace all the classes of surfactants that provide a stable emulsion of the active ingredient with or without solvent. In this way, the surfactants employed for emulsifying the product may belong to the classes of non-ionics such as ethoxylated alkylamine, amine oxides, block copolymers, ethoxylated alcohols, ethoxylated alkynolamides, ethylene glycol esters, fatty acids, ethoxylated lauryl ether, alkoxylated random copolymer, ethoxylated esters, ethoxylated acids, ethoxylated alcohols, ethoxylated or anionic amines as, for example, phosphatated alkyl, phosphated ethers, sulfated ethers, sulfonated alkyl nathpthe, condensed naphthealene sulfonates, sulfonic acids of aromatic hydrocarbons and salts thereof, fatty alcohol sulfates, carboxylic alkyl ether acids and salts thereof, mono- or di-alkyl sulfonosuccinamates, alkyl phosphates, sulfonic acids and alkyl benzene salts thereof, alpha olefin sulfosuccinates. In addition to these, one may also use amphoteric or cationic surfactants, these two classes being less commonly employed.

Additionally, a coloring agent such as a dye or a pigment is included in the product when employed for the treatment of seeds, so that an observer will be able to identify immediately whether the seed has been treated. The dye will also indicate the uniformity of the treatment carried out.

The processes of preparing the compositions of the present invention comprise mixing the active compound carbosulfane with the additional inert ingredients, employing conventional equipment for preparing mixtures, as for example, stainless-steel tanks with a stirrer and for packing the final product to be commercialized. The operational conditions are those already known from the prior art for the preparation of compositions/formulations comprising the active compound carbosulfane.

The process for controlling insects/mites/nematode according to the present invention comprises treating and/or applying an effective amount of the compositions disclosed herein to the place to be protected and/or to the insect itself. The ranges employed vary according to the crop. For the treatment of seeds, one recommends from 600 to 700 g of active compound per 100 kg of seeds. In the case of a formulation whose concentration is of about 800 g/L, this quantity of active compound would range from 0.8 to 0.9 liters of the pesticidal composition. For the treatment of leaves, each crop requires a specific dose of the active compound. A few examples of crops and the respective doses are described hereinafter, including an example of amount of product of a pesticidal composition at a concentration of about 700 g/L, claimed herein.

| | | Dose | |
|---|---|---|---|
| | | Active | Pesticidal |
| Crops | Pests | compound | Composition |
| Cotton | Cotton-plant louse (Aphis | 110 to 130 g/ha | 157 to 185 mL/ha |
| | gossypii) | | |
| Irrigated | Root disease | 300 to 500 g/ha | 428 to 714 mL/ha |
| rice | (Oryzophagus oryzae) | | |
| Potato | Plant mouse | (10 to 30) g/ | 14 to 42 mL/ha |
| | (Macrosiphum | 100 L water | |
| | euphorbiae) | | |
| Tomato | Sapping fly (Lyriomyza | (10 to 30) g/ | 14 to 42 mL/ha |
| | ssp) | 100 L water | |

Preferably, the proportions of the active compound at the doses applied for the cultures are as follows:

| | | Dose | |
|---|---|---|---|
| | | | Pesticidal |
| Crops | Pests | Active compound | Composition |
| Cotton | Cotton-plant mouso (Aphis | 120 g/ha | 171 mL/ha |
| | gossypii) | | |
| Irrigated | Rout disease | 400 g/ha | 571 mL/ha |
| rice | (Oryzophagus oryzae) | | |
| Potato | Potato mouse | 20 g/100 L | 28 mL/ha |
| | (Macrosiphum | water | |
| | euphorbiae) | | |
| Tomato | Sapping fly (Lyriomyza | 20 g/100 L | 28 mL/ha |
| | ssp) | water | |

As general advantages of the present invention, the following are cited:
high concentration of the active compound carbosulfane;
low concentration of the aromatic solvent,
significant reduction in the number of packages on the (cultivation) farm, thus reducing the volume of product transported, significantly attenuating the negative impacts of the active compounds on the environment, as for example, disposal of contaminated packages, reducing the consumption of natural resources such as petroleum, reducing air pollution, etc.;
the physico-chemical characteristics of the product guarantee more protection for the plants by reducing the losses due to attacks by pests, thus bringing about an increase in productivity per cultivated hectare.

As specific advantages for the treatment of seeds, the differentiating factor of the presently claimed composition as compared to the compositions known from the prior art is the absence of water and/or another adjuvant in the formulation that might impart polarity to the product, which considerably reduces the risk of early germination of the seed, thus enabling one to treat the seeds before planting them. Another important advantage of the product proposed by the present invention is related to the leaching of the active compound from the post-plantation seed, which exhibits a reduced non-polar characteristic in comparison with that of conventional products utilized, thus providing better washability in contact with water and thereby bringing a better control of the pests and protection for the plant for a longer period of time, and bringing about higher productivity for the farming producer.

In the case of a formulation for treating leaves, the advantage with respect to the commercialized formulations is the absence of surfactants based on ethoxylated alkyl phenol, which provides to the final product a reduction of toxicity non-utilization of this class of surfactants that is being banned from the market because it is carcinogenic.

For the treatment of leaves, solutions containing the above-mentioned active compound carbosulfane may contain, if necessary, in addition to the diluting agent, emulsifying agents for preparing concentrates that can be emulsified at the suitable concentration and applied to treat leaves. This concentration may range from 5 to 15% by weight.

The illustrative examples presented hereinafter will serve to describe the present invention in a better way. However, the formulations described therein refer only to a few embodiments of the present invention and should not be taken as being limitative of the scope of the invention.

All the percentages indicated in the examples are percentages by weight, based on the total weight of the formulation.

### EXAMPLES

The process of making the concentrated pesticidal compositions of the present invention for the treatment of seeds and/or leaves is based on the following formula:

### Example 1

### Preparation of a Composition Comprising Carbosulfane for the Treatment of Seeds

To prepare 10,000 liters of composition for treating seeds at the concentration of 800 g/L, one uses:

| Components | Amount |
|---|---|
| Technical carbosulfane (contents of | 8972.19 kg |
| the active compound: 89.16%) | |
| Isobutanol | 1074.63 kg |
| Methyl Violet dye | 50.00 kg |

Procedure for preparation:

I—In a clean and dry stainless-steel tank with capacity for 10,000 liters, equipped with a stirrer, add the required amount of technical carbosulfane;

II—add the required amount of the diluting agent isobutanol keeping the stirring until complete dissolution of the technical carbosulfane has been achieved;

III—add the required amount of the coloring agent (in the example, Methyl Violet):

IV—send the solution obtained in step III to the Quality Control;

V—distribute it in the final containers after approval.

### Example 2

### Preparation of a Composition Comprising Carbosulfane for Treating Leaves

To prepare 10,000 liters of composition for treating leaves at the concentration of 700 g/L, one uses:

| Component | Amount |
|---|---|
| Technical carbosulfone (contents of | 7851.35 kg |
| active compound: 89.16%) | |
| Solvent AB-9 | 1328.65 kg |
| Mixture of anionic and non-ionic emulsifier | 1020.00 kg |

Procedure for preparation:

I—In a clean and dry stainless-steel tank with capacity for 10,000 liters, equipped with a stirrer, add the required amount of technical carbosulfane;

II—add the required amount of Solvent AB-9, keeping the stirring until complete dissolution of the technical carbosulfane has been achieved;

III—add to the solution obtained in step II the required amount of the mixture of emulsifiers until complete homogenization has been achieved;

IV—send the solution obtained in step III to the Quality Control;

V—distribute it in the final containers after approval.

An embodiment of the invention having been described on the basis of examples, one should understand that the present invention embraces other embodiments, being limited only by the scope of the accompanying claims.

1. A concentrated pesticidal composition, characterized by comprising, as an active substance, the active compound carbosulfane at the concentration range of from 51 to 90% by weigh, in combination with agrochemically acceptable excipients.

2. The concentrated pesticidal composition according to claim 1, characterized in that the active compound carbosulfane is present at the concentration range of from 70 to 80% by weight.

3. The pesticidal composition according to claim 1 or 2, characterized by being for application in the treatment of seeds, wherein the active compound carbosulfane is combined with a diluting agent present at the concentration of 5 to 49% by weight.

4. The pesticidal composition according to any one of claims 1 to 3, characterized in that the diluting agent is other than water.

5. The pesticidal composition according to any one of claims 1 to 4, characterized in that the liquid diluting agents may be petroleum distillates such as cyclic or linear, aliphatic or aromatic, branched or non-branched, unsaturated or saturated hydrocarbons, as for example, AB-9 and/or AB-11; isoparaffin, n-heptane, cyclohexane, in addition ketones, alcohols, esters, ethers, amides, amines, with chain sizes preferably in the range C1-C10, for example, cyclohexanone, dimethylformamide, propylene carbonate, n-methylpirrolidone, among other non-phitotoxic solvents, and/or mixtures thereof, at the concentration of 5 to 49%

6. The pesticidal composition according to claim 1 or 2, characterized by being for application in the treatment of leaves, wherein the active compound carbosulfane is combined with a diluting agent at the concentration of from 5 to 49% by weight and an emulsifying agent at the concentration of from 5 to 15% by weight.

7. The pesticidal composition according to claim 1, 2 or 6, characterized in that the diluting agent is other than water, and the emulsifying agent is other than a surfactant based on ethoxylated alkyl phenol.

8. The pesticidal composition according to claim 1, 2, 6 or 7, characterized in that the liquid diluting agents are selected petroleum distillates such as cyclic or linear, aliphatic or aromatic, branched or non-branched, unsaturated or saturated hydrocarbons, as for example, AB-9 and/or AB-11; isoparaffin, n-heptane, cyclohexane, in addition ketones, alcohols, esters, ethers, amides, amines, with chain sizes preferably in the range C1-C10, for example, cyclohexanone, dimethylformamide, propylene carbonate, n-methylpirrolidone, among other non-phitotoxic solvents, and/or mixtures thereof, at the concentration of 5 to 49%

9. The pesticidal composition according to any one of claims 1 to 8, characterized by being insecticidal, acaricidal and/or nematocidal.

10. The pesticidal composition according to any of claims 1 to 5, characterized in that it further comprises adding a coloring agent in the case of formulations for the treatment of seeds.

11. A process for preparing a concentrated pesticidal composition as defined in any one of claims 1 to 10, characterized in that it comprises mixing, at desired proportions for application to seeds and/or leaves, of the active compound carbosulfane, in combination with liquid diluting agents and, optionally, with or without surfactants as emulsifying agents.

12. A process for controlling insects/mites/nematodes, characterized in that it comprises applying to the place to be protected or to the insect itself, an agrochemically effective amount of an insecticidal/acaricidal/nematocidal composition as defined in any one of claims 1 to 10 and/or obtainable by the process as defined in claim 11.

13. The process according to claim 12, characterized in that, for the treatment of seeds, the amount of active compound in the final composition ranges from 0.8 to 0.9 kg/liters, and for the treatment of crops the amount of active compound in the final composition ranges from 14 to 714 mL/ha.

14. A use of a concentrated pesticidal composition as defined in any one of claims 1 to 10 and/or obtainable by the process as defined in claim 11, characterized by being for the control of insects/mites/nematodes on seeds and/or plants.

15. A use of an effective amount of the active compound carbosulfane in combination with an adequate diluting agent, characterized by being for the preparation of a concentrated pesticidal composition for application in treating seeds.

16. The use according to claim 15, characterized in that the diluting agent is other than water.

17. The use according to claims 15 or 16, characterized in that the liquid diluting agents are selected from petroleum distillates such as cyclic or linear, aliphatic or aromatic, branched or non-branched, unsaturated or saturated hydrocarbons, as for example, AB-9 and/or AB-11; isoparaffin, n-heptane, cyclohexane, in addition ketones, alcohols, esters, ethers, amides, amines, with chain sizes preferably in the range C1-C10, for example, cyclohexanone, dimethylformamide, propylene carbonate, n-methylpirrolidone, among other non-phitotoxic solvents, and/or mixtures thereof, at the concentration of 5 to 49%

18. The use of an effective amount of the active compound carbosulfane in combination with a suitable liquid diluting agent and at least one emulsifying agent, characterized by being for the preparation of a concentrated pesticidal composition for application in treating leaves.

19. The use according to claim 18, characterized in that the diluting agent is other than water and/or another adjuvant that might impart polarity of the final composition, and the emulsifying agent is other than a surfactant based on ethoxylated alkyl phenol.

20. The use according to claim 18 or 19, characterized in that the liquid diluting agents are selected from petroleum distillates such as cyclic or linear, aliphatic or aromatic, branched or non-branched, unsaturated or saturated hydrocarbons, as for example, AB-9 and/or AB-11; isoparaffin, n-heptane, cyclohexane, in addition ketones, alcohols, esters, ethers, amides, amines, with chain sizes preferably in the range C1-C10, for example, cyclohexanone, dimethylformamide, propylene carbonate, n-methylpirrolidone, among other non-phitotoxic solvents, and/or mixtures thereof, at the concentration of 5 to 49% by weight of the formulation, and the emulsifying agent is a mixture of anionic and non-ionic surfactants based on salified alkyl aryl sulfonate, alkoxylated alcohol and alkoxylated fatty ester solubilized in aromatic solvents and light alcohols.
